(19) United States
(12) Patent Application Publication
(10) Pub. No.: US 2026/0135215 A1
(43) Pub. Date: May 14, 2026

(54) FIRE CONFINING VENTILATION DUCT DESIGN FOR BATTERY RACKS

(71) Applicant: Caterpillar Inc., Peoria, IL (US)

(72) Inventors: Krishna Prasath Ramabadhran, Krishnagiri (IN); Prakash Prashanth Ravi, Bengalore (IN)

(73) Assignee: Caterpillar Inc., Peoria, IL (US)

(21) Appl. No.: 18/946,528

(22) Filed: Nov. 13, 2024

(51) Int. Cl. H01M 50/204; H01M 50/383

(52) U.S. Cl. CPC H01M 50/204; H01M 50/383

(57) ABSTRACT

A battery rack includes a battery rack having a rack inlet and at least one rack outlet. A battery rack can further include a ventilation duct positioned on the battery rack, the ventilation duct having an inlet nozzle, an outlet nozzle. The battery rack can further include wherein the ventilation duct positioned such that the inlet nozzle substantially aligns with the rack inlet and the outlet nozzle substantially aligns with the rack outlet.

### TECHNICAL FIELD

This disclosure relates generally to battery racks and more particularly to a fire confining ventilation duct design for battery racks.

### BACKGROUND

Battery racks are commonly arranged in close proximity and may share a ventilation system to maintain optimal operating conditions. While such configurations offer spatial efficiency, there are safety hazards associated with the shared ventilation ducting system. One notable concern arises in the context of fire incidents within a single battery rack, where the interconnected ventilation infrastructure could facilitate the rapid spread of fire to adjacent racks. The hazard of a fire extending through shared ventilation ducting systems arises due to the combustible nature of battery components. In the event of a fire within a battery rack, the shared ventilation network can act as a conduit, enabling the propagation of flames, heat, and toxic byproducts to neighboring racks. This scenario underscores the critical need for comprehensive fire prevention and containment strategies to mitigate the risk of collateral damage and enhance overall safety in environments where multiple battery racks coexist.

For example, German Pat. App. No. 102,021,206,572 describes a high voltage battery system. The high voltage battery system includes a plurality of lithium-ion battery cells in whose cell housing there is active material and a liquid electrolyte. The high-voltage battery system may also include an electrolyte circuit in which the battery cells are fluidically integrated, so that an inlet pump and/or an outlet pump enables an electrolyte flow through the respective battery cell. The high voltage battery system may be utilized for a circulation process in which the electrolyte in the battery cell can be circulated, or for a filling process in which a new electrolyte can be fed into the respective battery cell, or for an emptying process in which old electrolyte can be removed from the respective battery cell.

### SUMMARY OF THE INVENTION

A first aspect provided herein relates to a battery having a rack inlet and at least one rack outlet. The battery rack further includes a ventilation duct positioned on the battery rack, the ventilation duct having an inlet nozzle, an outlet nozzle. The battery rack further includes the ventilation duct positioned such that the inlet nozzle substantially aligns with the rack inlet and the outlet nozzle substantially aligns with the rack outlet.

A second aspect provided herein relates to a method of assembling a battery rack, the method including providing a battery rack with a rack inlet and a rack outlet. The method further includes aligning an inlet nozzle of a ventilation duct with the rack inlet. The method further includes aligning an outlet nozzle of the ventilation duct with the rack outlet. The method further includes mechanically coupling the ventilation duct to the battery rack.

A third aspect provided herein relates to a battery rack system having a battery rack having a battery, a rack inlet, and a rack outlet. The system can further include a ventilation duct positioned on the battery rack, the ventilation duct including a top member with an inlet nozzle and an outlet nozzle, and a bottom member with an internal barrier positioned between the inlet nozzle and the outlet nozzle. The system can further include the ventilation duct positioned such that the inlet nozzle is in fluid communication with the rack inlet and the outlet nozzle fluid is in fluid communication with the rack outlet.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 illustrates a front side perspective view of an embodiment of a fire confining ventilation duct coupled to a battery rack with integrated fireproof structures;

FIG. 2 illustrates a top side perspective view an embodiment of a battery rack with integrated fireproof structures;

FIG. 3 illustrates an exploded front side perspective view of an embodiment of a battery rack wall with integrated fireproof structures;

FIG. 4 illustrates a top plan view of an embodiment of a battery rack wall with integrated fireproof structures;

FIG. 5 illustrates a top plan view of an embodiment of a pair of abutted battery rack end walls with integrated fireproof structures;

FIG. 6 illustrates an exploded front side perspective view of an embodiment of a fire confining ventilation duct; and

FIG. 7 illustrates a top plan view of an embodiment of a fire confining ventilation duct coupled to a battery rack with the top cover removed;

FIG. 8 illustrates a flowchart of an embodiment of a method of assembling a battery rack system.

FIG. 9 illustrates a flowchart of an embodiment of a method of assembling a battery rack wall.

### DETAILED DESCRIPTION

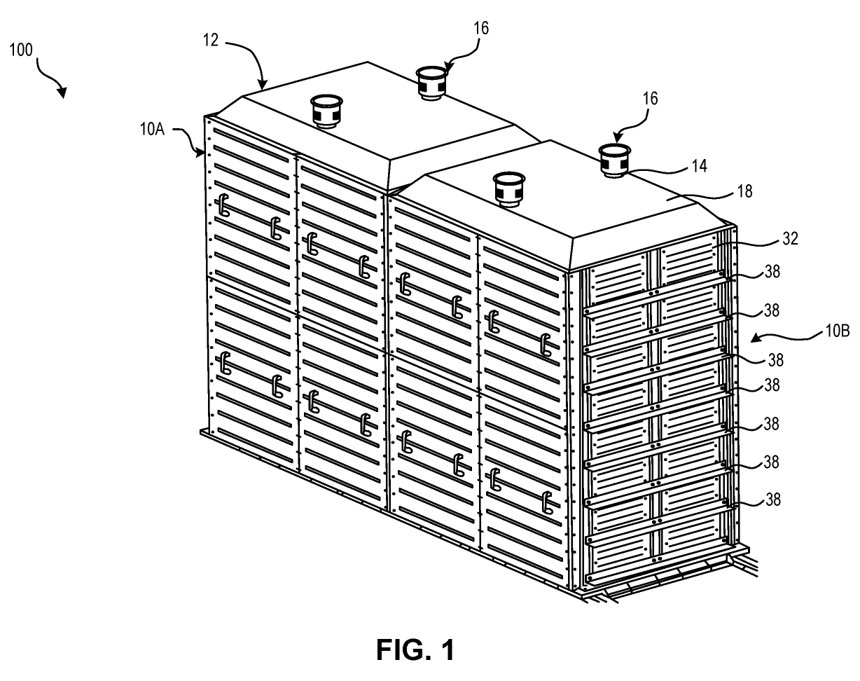

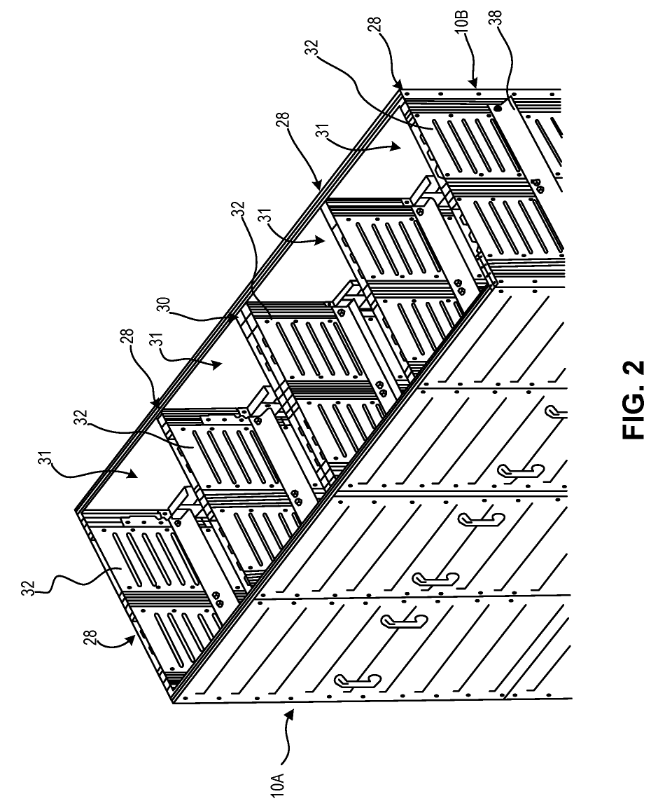

Reference is now made to FIGS. 1 and 2, which depicts a front side perspective view of an embodiment of a pair of adjacent battery racks 10A, 10B with integrated fireproof, fire-resistant, or thermal barrier 32 and each coupled to a fire confining ventilation duct 12 in FIG. 1, and with the fire confining ventilation ducts 12 removed in FIG. 2. A battery rack system 10 is an enclosure that includes a plurality of walls 28 and is configured to support batteries therein. As shown in FIG. 2, a pair of battery racks 10A, 10B, are positioned proximate to one another such that one of their respective walls 28 touch or contact one another to form an end wall 30. A single battery rack 10 can have multiple or various battery storage containers 31 within the same battery rack 10. It should be understood, that while the battery rack 10 depicted in FIGS. 1 and 2 depict a battery rack 10 with two battery storage containers 31, other configurations are also envisioned. For example, a battery rack 10 can be configured with a single battery storage container 31 such that both of the side walls 28 are configured as end walls 30. As another example, a battery rack 10 can be configured with three battery storage containers 31 with two internal walls 28 and a pair of end walls 30. A battery rack 10 can be configured with any number of suitable or desirable battery storage containers 31.

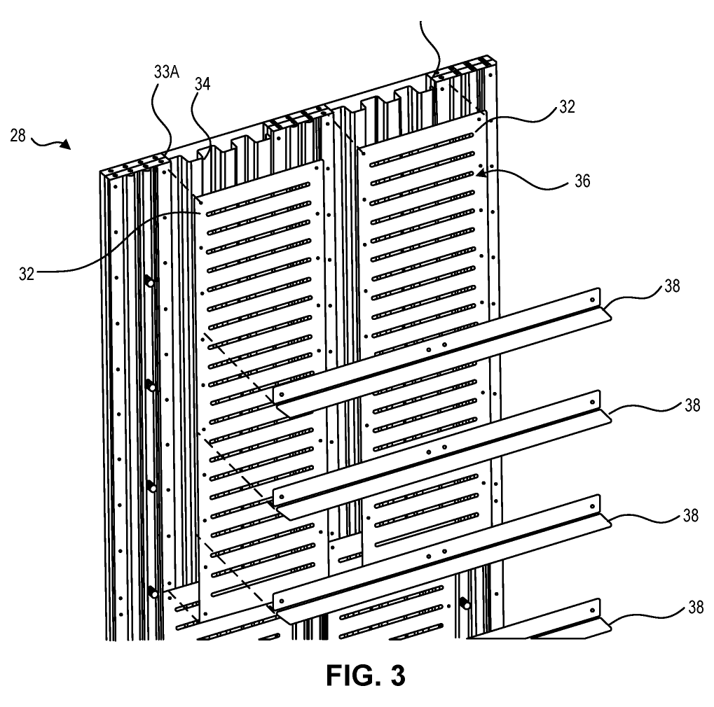

Reference is now made to FIG. 3, which depicts an exploded front side perspective view of an embodiment of a battery rack 10 wall 28. A battery rack 10 has or includes a plurality of walls 28 having a plurality of shelves 38 to support batteries thereon. The wall 28 includes a corrugated member 34 extending from a first end 33A to an opposed second end 33B of the wall 28. The corrugated member 34 is substantially defined by a series of flow channels 35, configured to facilitate the flow of a fluid through each respective channel 35. The wall 28 can also include a thermal barrier 32 secured to, affixed to, or otherwise coupled to one or both sides of the wall 28. The thermal barrier 32 is positioned about the portion of the wall 28 that includes the corrugated member 34 and includes an opening 36 therethrough. The opening 36 is configured to facilitate or otherwise allow the fluid flowing through a respective channel 35 to pass through the opening 36 and enter or exit the interior of the battery rack 10 and the respective battery storage container 31.

Thermal barrier 32 can be formed of fire-resistant plastics such as polyimides, polyphenylene sulfide (“PPS”), polyetherimide (“PEI”), or any other suitable or desirable fire-resistant plastic material. Thermal barrier 32 can be formed of fire-resistant ceramics such as alumina ceramic, which has high heat resistance and is may used in applications where fire resistance is desired, silicon carbide (“SiC”) which is generally known for its thermal conductivity and resistance to high temperatures, zirconia ceramic which exhibits high heat resistance and is used in various industries, including aerospace and medical, for its fire-resistant properties, or any other suitable or desirable fire-resistant ceramic material. Thermal barrier 32 can also be formed of glass-fiber reinforced plastics (“GRP”), ceramic matrix composites (“CMC”), fire-resistant polymer composites, or any other suitable or desirable fire-resistant or fireproof material.

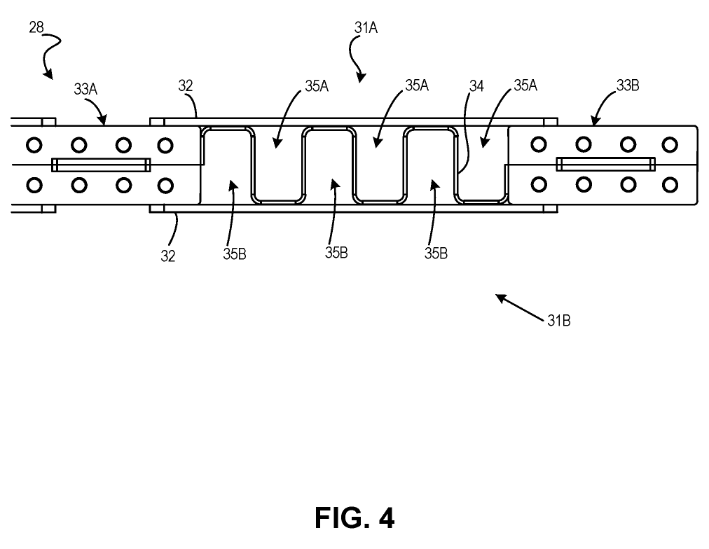

Reference is now made to FIG. 4, which depicts a top plan view of a battery rack 10 wall 28 with integrated a thermal barrier 32. As shown the corrugated member 34 extends from a first end 33A to an opposed second end 33B of the wall 28. The fluid flowing through the flow channels 35A, 35B flows in a direction perpendicular to the view depicted in FIG. 4. As the fluid enters the corrugated members 34 flow channels 35A, 35B the fluid will flow along the flow channels 35A, 35B and into a respective battery storage location 31A, or 31B depending on if the fluid is flowing through flow channel 35A or 35B respectively. A fluid flowing through flow channel 35A is in fluid communication with battery storage container 31A through the opening 36 formed in the thermal barrier 32. Similarly, a fluid flowing through flow channel 35B is in fluid communication with battery storage container 31B through the opening 36 formed in the thermal barrier 32.

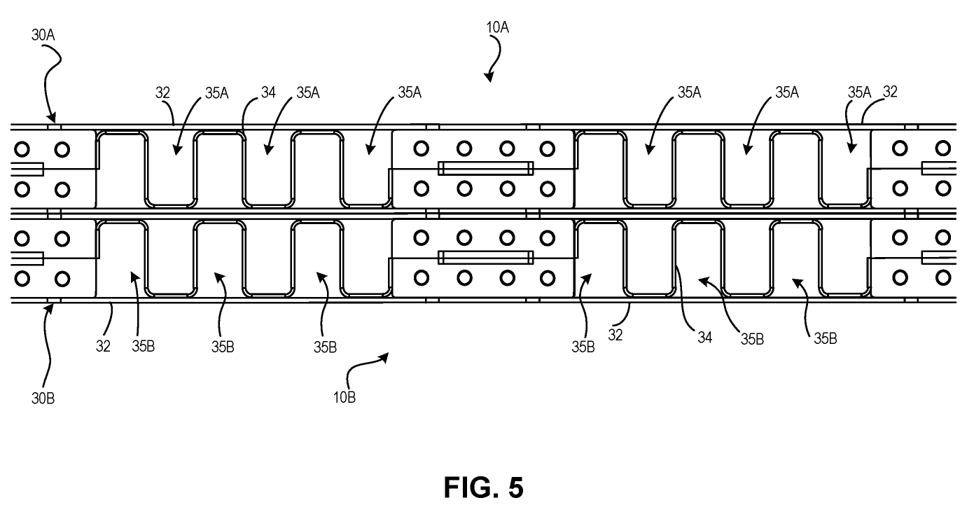

Reference is now made to FIG. 5, which depicts a depicts a top plan view of a battery rack 10 end wall 30. A battery rack 10 end wall 30 is configured similarly to wall 28 with like parts serving like functions. An end wall 30 is configured to only allow fluid to flow into one side of the end wall 30. As such, a pair of end walls 30A, 30B can be placed or positioned proximate to one another, even contacting one another without the fluid from one end wall 30 from contacting, interacting with, or otherwise mixing with the fluid from the adjacent end wall 30. As shown in FIG. 5, a pair of end walls 30A, 30B contact or about one another, yet the fluid flowing through end wall 30 a is only allowed to enter or exit battery rack 10A while similarly the fluid flowing through end wall 30B may only enter battery rack 10B. This can be accomplished by placing or affixing plugs in the inactive flow channels 35 of the corrugated member 34. In other embodiments, solid walls are affixed to the side of the end wall 30 with the inactive flow channels 35 such that any fluid flowing into the inactive flow channels 35 cannot enter a battery rack 10 from the inactive flow channel 35. In other embodiments, the inlet openings 26 of the bottom member 20 can be configured to cover the inactive flow channels 35 such that fluid is only allowed to flow through the active flow channels 35.

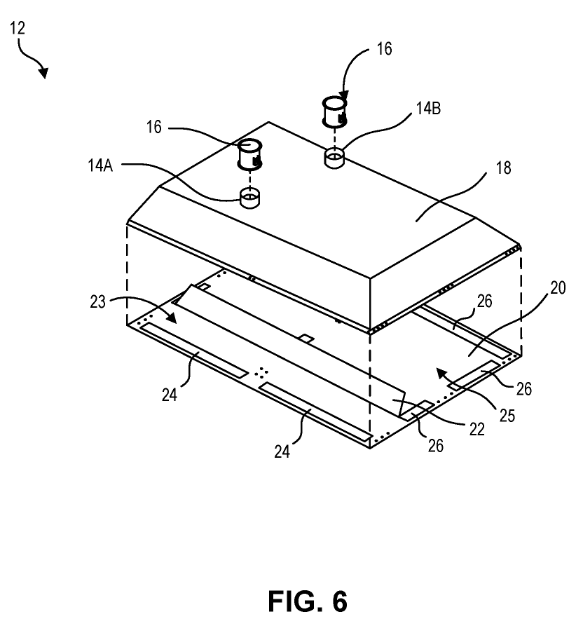

Reference is now made to FIG. 6, which depicts an exploded front side perspective view of an embodiment of a fire confining ventilation duct 12. A fire confining ventilation duct 12 includes a top member 18 with an inlet nozzle 14A and an outlet nozzle 14B coupled to a bottom member 20. The bottom member 20 includes an inlet chamber 23, an outlet chamber 25, and a flow barrier 22 positioned between the inlet chamber 23 and the outlet chamber 25. The inlet chamber 23 can have or include an outlet opening 24 positioned about an edge of the bottom member 20 while the outlet chamber 25 can have or include an inlet opening 26 positioned about the remaining edges of the bottom member 20. The outlet opening 24 and the inlet opening 26 are formed as openings or flow passages through the bottom member 20. It should be understood that while there are presently two outlet openings 24 depicted, other configurations are also envisioned. For example, a bottom member 20 can have a single outlet opening 24, three outlet openings 24, or any other suitable or desirable number of outlet openings 24. It should be understood that while there are presently a plurality of inlet openings 26 depicted, other configurations are also envisioned. For example, a bottom member 20 can have a single inlet opening 26, three inlet openings 26, or any other suitable or desirable number of inlet openings 26.

The bottom member 20 is coupled to the battery rack 10 in a manner such that air or any other cooling fluid may only enter the battery rack 10 via the outlet openings 24 in the bottom member 20. Similarly, air or any other fluid present in the battery rack 10 may only exit the battery rack 10 through the inlet openings 26 in the bottom member 20. It should be understood, that while the fire confining ventilation duct 12 is depicted as being coupled to a top end of the battery rack 10, other configurations are also envisioned. For example, the fire confining ventilation duct 12 can be coupled to a bottom end of the battery rack 10. As another example, a fire confining ventilation duct 12 can be configured as a two-part system, with an inlet fire confining ventilation duct 12 with only a single nozzle 14 coupled to one end of a battery rack 10 and an outlet fire confining ventilation duct 12 with a single outlet nozzle 14 coupled to the opposed opposite end of the battery rack 10.

With continued reference to FIG. 6, the barrier 22 is positioned between the inlet chamber 23 and the outlet chamber 25 and is configured to prevent the flow of air or other fluids from the inlet chamber 23 into the outlet chamber 25, and vice versa. The barrier 22 extends from a top surface of the bottom member 20 and contacts the inner surfaces of the top member 18 in a manner that at least substantially seals or prevents the fluid in the inlet chamber 23 from mixing or otherwise directly interacting with the fluid present in the outlet chamber 25. As the barrier 22 prevents the fluid present in the inlet chamber 23 from mixing or otherwise interacting with the fluid present in the outlet chamber 25 the temperature of the fluid and me and inlet chamber 23 can remain relatively lower than the fluid present in the outlet chamber 25. It should be understood that while the inlet nozzle 14A and the outlet nozzle 14B are presently depicted as being on opposite ends of the top member 18, other configurations are also envisioned. For example, inlet nozzle 14A and the outlet nozzle 14B can be flipped or reversed such that the inlet cooling fluid enters through the nozzle 14B and the fluid that has passed through the battery rack 10 exits or otherwise passes through the nozzle 14A. Inlet nozzle 14A is configured to receive a flow of cooling fluid and facilitate the flow of the cooling fluid into the inlet chamber 23.

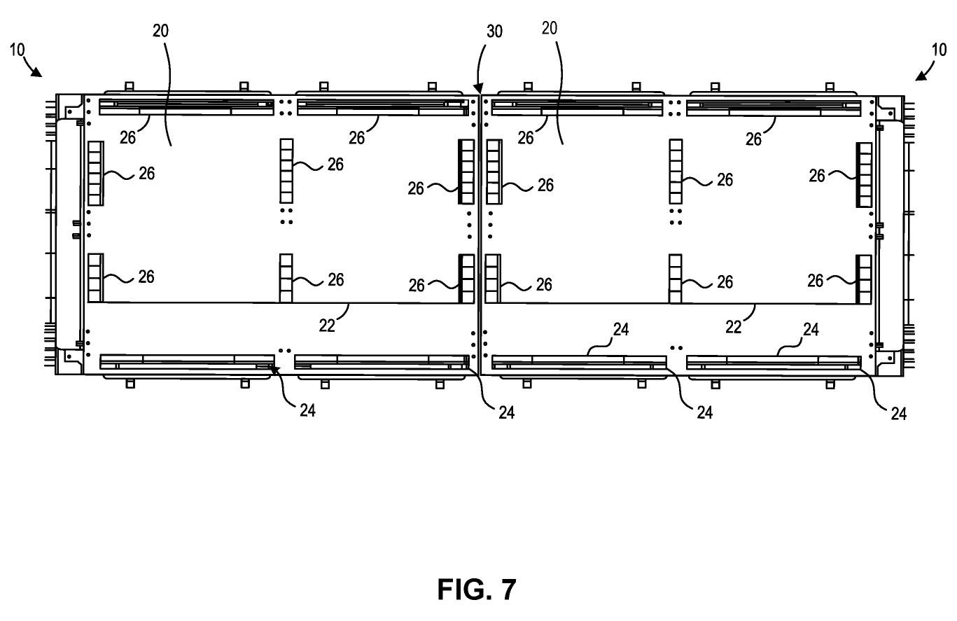

Reference is now made to FIG. 7, which depicts a top plan view of a fire confining ventilation duct 12 affixed on a pair of adjacent battery racks 10A and 10B (collectively 10) with the top member 18 removed. For each battery rack 10, once the cooling fluid has entered the inlet chamber 23, the cooling fluid will exit or otherwise pass through the inlet chamber 23 via the outlet opening 24 in the bottom member 20 without mixing or otherwise interacting with the fluid contained or present in the outlet chamber 25. Once the cooling fluid exits through the outlet opening 24 in the bottom member 20, the fluid then passes into and through the flow channels 35 in the walls 28 of the battery rack 10 and eventually passes through the inlet opening 26 to enter the outlet chamber 25. Then the fluid present in the outlet chamber 25 passes through the outlet nozzle 14B to be vented to the atmosphere, be cooled again for recirculation through the battery rack 10, or any other suitable or desirable routing for the fluid passing through the outlet nozzle 14B. The fluid that enters battery rack 10A will not mix or otherwise interact with the fluid circulating in adjacent battery rack 10B as there is no flow channel 35 or other flow passageway that goes between battery rack 10A and battery rack 10B.

Reference is again made to FIG. 6, a fire confining ventilation duct 12 can also include a valve or damper 16 coupled to the inlet nozzle 14A, the outlet nozzle 14B, or both. The damper 16 can be selectably configured to be a fully open state, a fully closed state, or any other partially open state in between a fully open state or a fully closed state. Configuring one or both of the dampers 16 to be in a fully closed state will substantially reduce or prevent the flow of air into the battery rack 10. This capability can be utilized when a fire or other elevated temperature is detected in the interior of the battery rack 10 to choke off a fire’s supply of air and thereby extinguishing the fire. Additionally, in the event that the fire is not extinguished by configuring one or both of the dampers 16 to be in a fully closed state, the heated air generated by the fire can only exit the battery rack 10 by entering the outlet chamber 25 and exiting the fire confining ventilation duct 12 through the outlet nozzle 14B. Thus, the heated air generated by the fire is prevented from mixing with or otherwise directly interacting with air that is intended to enter adjacent battery racks 10, thereby aiding in reducing the probability of the spread of the fire to the adjacent battery racks 10.

In some embodiments, the fire confining ventilation duct 12 is split into two disparate portions that are each individually coupled to the same end of the battery rack 10. In such implementations, a first fire confining ventilation duct 12 is configured with only a single inlet nozzle 14 and a single inlet chamber 23, while a second fire confining ventilation duct 12 is configured with only a single outlet nozzle 14 and a single outlet chamber 25. Either the first or the second fire confining ventilation duct 12 can be removed from the battery rack 10 and/or coupled to the battery rack 10 without the need to remove, couple, or otherwise interact with the other fire confining ventilation duct 12. In such implementations, neither fire confining ventilation duct 12 would require a barrier 22 as each fire confining ventilation duct 12 only interacts with or otherwise receives a single inlet or a single outlet fluid flow stream.

### INDUSTRIAL APPLICABILITY

A battery rack 10 is configured to contain or isolate any fluid flowing through it from any adjacent battery racks 10. In this manner, any unintended combustion, unplanned ignition, fire or any other situation where air contained within the battery rack 10 is heated well above normal values is contained within the battery rack 10 and does not flow into or otherwise mix with air within adjacent battery racks 10. Segregating the heated air in one battery rack 10 from adjacent battery racks 10 can aid in reducing the probability or otherwise minimizing the potential for a fire in one battery rack 10 from cascading, propagating, or otherwise causing or starting fires in adjacent battery racks 10. The thermal barrier 32 functions as a thermal insulator, helping to prevent the direct heat from one battery storage container 31 from interacting with or otherwise mixing with the air from an adjacent battery storage container 31.

A fire confining ventilation duct 12 is configured to isolate the fluid flowing through each individual battery rack 10 such that substantially the only fluids flowing through the battery rack 10 may only enter or exit the battery rack 10 through the fire confining ventilation duct 12. Once the fluid enters the inlet nozzle 14A, the only flow pathway for the fluid to exit the fire confining ventilation duct 12 is to flow through the flow channels 35 aligned with the bottom member 20 outlet opening 24, into the battery storage container 31, back up through the flow channels 35 aligned with the bottom member 20 inlet openings 26, and out the outlet nozzle 14B. In this manner, positive pressure is maintained on the inlet nozzle 14A side of the system to force or induce the fluid flow to proceed in the manner described above. Alternatively, negative pressure, or vacuum pressure, can be applied at the outlet nozzle 14B side of the system to induce the fluid to flow in the path and manner described above.

Isolation of the air from one battery storage container 31 from the adjacent battery storage container 31 is accomplished by the fact that air or fluid from one battery storage container 31 may only mix with or otherwise interact with air from an adjacent battery storage container 31 in the outlet chamber 25 of the fire confining ventilation duct 12. However, due to the positive pressure applied to the inlet nozzle 14A side of the system, or corresponding negative pressure applied to the outlet nozzle 14B side of the system, such mixed air from adjacent battery storage containers 31 is unable to, or otherwise prevented from reentering the battery storage container 31 through the inlet openings 26.

In some embodiments, a thermocouple or other temperature sensor can be coupled to the outlet nozzle 14B and be configured to register or record the temperature of the fluid passing through the outlet nozzle 14B. Such temperature readings can be analyzed and presented to an operator in the form of an alert for any battery rack 10 with outlet nozzle 14B fluid temperatures that exceed or are approaching a predetermined upper temperature limit for the batteries stored in the battery rack 10. In certain implementations, the sensor can be communicatively coupled to the dampers 16 and configured to transmit a signal to the dampers 16 to transition to fully closed states to fully isolate the fluid in the battery rack 10 or other suitable or desirable states.

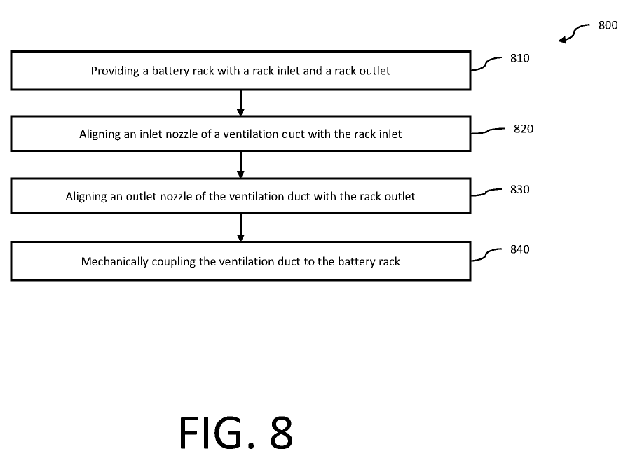

Reference is now made to FIG. 8, which depicts a block flow diagram illustrating a method 800 in which a battery rack system 10 may be assembled. The method 800 includes block 810 by providing a battery rack 10 with a rack inlet and a rack outlet. The method 800 further includes block 820 by aligning an inlet nozzle 14A of a ventilation duct 12 with the rack inlet. The method 800 further includes block 830 by aligning an outlet nozzle 14B of the ventilation duct 12 with the rack outlet. The method 800 further includes block 840 by mechanically coupling the ventilation duct 12 to the battery rack 10.

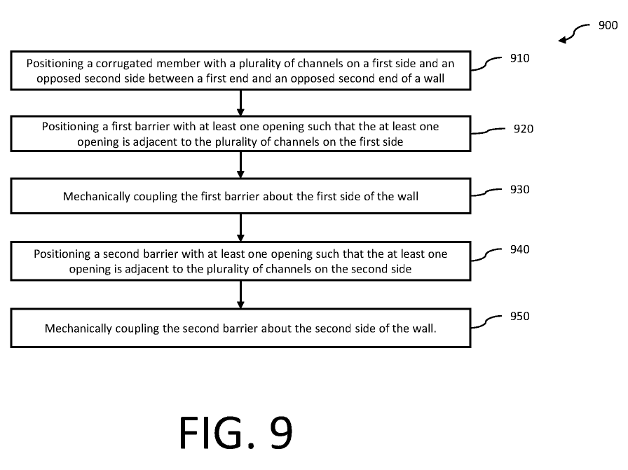

Reference is now made to FIG. 9, which depicts a block flow diagram illustrating a method 900 in which a battery rack 10 wall 28 may be assembled. The method 900 includes block 910 by positioning a corrugated member 34 with a plurality of channels 35 on a first side and an opposed second side between a first end 33A and an opposed second end 33B of a wall 28. The method 900 further includes block 920 by positioning a first thermal barrier 32 with at least one opening 36 such that the at least one opening 36 is adjacent to the plurality of channels 35 on the first side. The method 900 further includes block 930 by mechanically coupling the first thermal barrier 32 about the first side of the wall 28. The method 900 further includes block 940 by positioning a second thermal barrier 32 with at least one opening 36 such that the at least one opening 36 is adjacent to the plurality of channels 35 on the second side. The method 900 further includes block 950 by mechanically coupling the second thermal barrier 32 about the second side of the wall 28.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely exemplary in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

What is claimed is:

1. A battery rack comprising:
a battery rack having a rack inlet and at least one rack outlet;
a ventilation duct positioned on the battery rack, the ventilation duct having an inlet nozzle and an outlet nozzle; and
the ventilation duct positioned such that the inlet nozzle is substantially aligned with the rack inlet and the outlet nozzle is substantially aligned with the at least one rack outlet.

2. The battery rack of claim 1, wherein the ventilation duct has a bottom wall coupled to an internal barrier, the bottom wall having a bottom wall outlet substantially aligned with the rack inlet and a bottom wall inlet substantially aligned with the at least one rack outlet.

3. The battery rack of claim 1, further comprising an inlet damper coupled to the inlet nozzle and configured to transition from an open state to a closed state, and vice versa.

4. The battery rack of claim 1, further comprising an outlet damper coupled to the outlet nozzle and configured to transition from an open state to a closed state, and vice versa.

5. The battery rack of claim 1, further comprising a sensor configured to detect a temperature of a fluid passing through the outlet nozzle.

6. The battery rack of claim 1, wherein the at least one rack outlet is a plurality of rack outlets.

7. The battery rack of claim 1, wherein the rack inlet is a plurality of rack inlets.

8. The battery rack of claim 1, further comprising an internal barrier positioned between the inlet nozzle and the outlet nozzle.

9. A method of assembling a battery rack comprising:
providing a battery rack with a rack inlet and a rack outlet;
aligning an inlet nozzle of a ventilation duct with the rack inlet;
aligning an outlet nozzle of the ventilation duct with the rack outlet; and
mechanically coupling the ventilation duct to the battery rack.

10. The method of claim 9, further comprising aligning an outlet opening of a bottom wall of the ventilation duct with the rack inlet.

11. The method of claim 9, further comprising aligning an inlet opening of a bottom wall of the ventilation duct with the rack outlet.

12. The method of claim 9, further comprising aligning an inlet opening of a bottom wall of the ventilation duct with the rack outlet.

13. A battery rack system comprising:
a battery rack having a battery, a rack inlet, and a rack outlet;
a ventilation duct positioned on the battery rack, the ventilation duct including a top member with an inlet nozzle and an outlet nozzle, and a bottom member with an internal barrier positioned between the inlet nozzle and the outlet nozzle; and
the ventilation duct positioned such that the inlet nozzle is in fluid communication with the rack inlet and the outlet nozzle is in fluid communication with the rack outlet.

14. The system of claim 13, further comprising an outlet damper coupled to the outlet nozzle and configured to transition from an open state to a closed state, and vice versa.

15. The system of claim 13, further comprising an inlet damper coupled to the inlet nozzle and configured to transition from an open state to a closed state, and vice versa.

16. The system of claim 13, further comprising an outlet opening formed in the bottom member and substantially aligned with the rack inlet.

17. The system of claim 13, further comprising an inlet opening formed in the bottom member and substantially aligned with the rack outlet.

18. The system of claim 13, further comprising a sensor configured to detect a temperature of a fluid passing through the outlet nozzle.

19. The system of claim 13, wherein the rack outlet is a plurality of rack outlets.

20. The system of claim 13, wherein the rack inlet is a plurality of rack inlets.
